(19) United States
(12) Patent Application Publication
(10) Pub. No.: US 2025/0005768 A1
(43) Pub. Date: Jan. 2, 2025

(54) IMAGE PROCESSING DEVICE, IMAGE PROCESSING METHOD, AND PROGRAM

(71) Applicant: NIPPON TELEGRAPH AND TELEPHONE CORPORATION, Tokyo (JP)

(72) Inventors: Daisuke UCHIBORI, Tokyo (JP); Wataru ITO, Tokyo (JP); Kazuaki WATANABE, Tokyo (JP); Yosuke SAKURADA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 18/710,287

(22) PCT Filed: Aug. 8, 2022
(86) PCT No.: PCT/JP2022/030335

§ 371 Date: May 15, 2024

(30) Foreign Application Priority Data
Nov. 17, 2021 (WO) PCT/JP2021/042300

(51) Int. Cl. G06T 7/246

(52) U.S. Cl. CPC G06T 7/246; G06T 2207/10016; G06T 2207/10032; G06T 2207/20021

(57) ABSTRACT

An image processing device (10) according to the present disclosure includes a feature point detection tracking unit (12) that detects a feature point in a first frame that is a frame at a first time, tracks the feature point from the first time to a second time later than the first time, and calculates a two-dimensional vector indicating a motion of the feature point, a feature point movement amount calculation unit (13) that calculates a movement amount of the feature point based on the calculated two-dimensional vector, and a determination unit (14) that determines whether the calculated movement amount is equal to or greater than a predetermined threshold value, and outputs a second frame as the clipped frame, the second frame being a frame at the second time, when the movement amount is determined to be equal to or greater than the threshold value.

### TECHNICAL FIELD

The present invention relates to an image processing device, an image processing method, and a program.

### BACKGROUND ART

Recently, in order to inspect a large infrastructure structure such as a road bridge or a road tunnel, for efficiency, a method in which an unmanned aerial vehicle (UAV) is flown around the infrastructure structure, an image of the infrastructure structure is captured by capturing equipment mounted on the UAV, and an inspector visually checks confirms the captured moving image has been used. The inspector usually creates a report of inspection results including a still image cut out from the moving image after checking by the moving image. In this case, it is desirable to cut out the frame as a still image from the moving image every time an arbitrary portion of the infrastructure moves by a certain amount in the moving image so that the portions of the infrastructure do not overlap in order to allot the state of the infrastructure to be grasped easily.

Various methods have been proposed for outputting a specific frame as a still image from a moving image. For example, NPL 1 and NPL 2 describe a method of outputting a frame as a still image at a timing when it is detected that an object captured within an angle of view of a moving image captured with a fixed viewpoint of capturing equipment has moved by a fixed amount. In addition, NPL 3 and NPL 4 describe a method of detecting a frame as a still image at the timing when a specific object within the angle of view, such as an airplane, ship, or bus, is detected, or when a specific motion such as eating is detected.

### CITATION LIST

### Non Patent Literature

[NPL 1] Norimichi IDEHARA, Fumi SUGITA, Development of automatic extraction and distribution system for keyframes in videos, Tama University Journal of Management and Information Sciences, pp. 195-198.2015.
[NPL 2] Shinya TAKAHASHI, Sakashi MAEDA, Koji HASHIMOTO, Naoyuki TSURUTA, Hiroyuki AI, Detection of Honeybee Waggle Dance Based on Inter-Frame Difference Images, Fukuoka University Engineering Journal, pp. 75-80.2018.
[NPL 3] Hayato KOBAYASHI, Keiji YANAI, Automatic Detection of Specific Action Scenes from Television Images, DEIM Forum, E5-6, 2016.
[NPL 4] Kazuya HIDUME, Keiji YANAI, Analysis of video data recognition using multi-frame, Research Report Computer Vision and Image Media, pp. 1-8, 2011.

### SUMMARY OF INVENTION

### Technical Problem

The methods described in NPL 1 and NPL 2 are directed to a moving image in which a viewpoint of capturing is fixed. Therefore, in a case of image-capturing is performed while the viewpoint is moving, all the objects in the field angle move, so that it is difficult to apply the methods described in NPL 1 and NPL 2. In addition, since the structure is uniform and does not involve movement in a moving image obtained by capturing an image of an infrastructure structure, it is difficult to apply a method for detecting a specific object or motion, as in NPL 3 and NPL 4.

An object of the present disclosure, which has been made in view of the above-mentioned problems, is to provide an image processing device, an image processing method, and a program that can output a frame at a timing when a predetermined portion of an object is displaced by a predetermined amount in a moving image obtained by capturing the object while moving a viewpoint.

### Solution to Problem

In order to solve the above problem, an image processing device according to the present disclosure is an image processing device for outputting a frame at a timing when a predetermined part of an object is displaced by a predetermined amount as a clipped frame from a moving image formed by a plurality of frames and capturing the object while a viewpoint is moved, the device including a feature point detection tracking unit that detects a feature point in a first frame that is a frame at a first time, tracking the feature point from the first time to a second time later than the first time, and calculates a two-dimensional vector indicating a motion of the feature point, a feature point movement amount calculation unit that calculates a movement amount of the feature point based on the calculated two-dimensional vector, and a determination unit that determines whether the calculated movement amount is equal to or greater than a predetermined threshold value, and outputs a second frame as the clipped frame, the second frame being a frame at the second time, when the movement amount is determined to be equal to or greater than the threshold value.

In addition, in order to solve the above problem, an image processing method according to the present disclosure includes is an image processing method for outputting a frame as a clipped frame at a timing when a predetermined portion of an object is displaced by a predetermined amount in a moving image formed by a plurality of frames and capturing the object while moving a viewpoint, the method including a step of detecting a feature point in a first frame that is a frame at a first time, tracks the feature point from the first time to a second time later than the first time, and calculating a two-dimensional vector indicating a motion of the feature point, calculating a movement amount of the feature point based on the calculated two-dimensional vector, and determining whether the calculated movement amount is equal to or greater than a predetermined threshold value, and outputting a second frame as the clipped frame, the second frame being a frame at the second time, when the movement amount is determined to be equal to or greater than the threshold value.

In addition, in order to solve the above problem, a program according to the present disclosure causes a computer to serve as the above-described image processing device.

### Advantageous Effects of Invention

According to an image processing device, an image processing method, and a program according to the present disclosure, in a moving image obtained by capturing an object while moving a viewpoint, a frame at a timing when a predetermined portion of the object is displaced by a predetermined amount can be output.

### BRIEF DESCRIPTION OF DRAWINGS

FIG. 1 is a diagram illustrating a configuration example of an image processing device according to a first embodiment of the present disclosure.

FIG. 2 is a flow chart illustrating an example of an operation of the image processing device illustrated in FIG. 1.

FIG. 3 is a diagram illustrating an example of a hardware configuration of the image processing device illustrated in FIG. 1.

FIG. 4 is a diagram illustrating a configuration example of an image processing device according to a second example of the present disclosure.

FIG. 5 is a diagram illustrating an example of setting of a feature point detection area in a frame by a feature point detection area setting unit illustrated in FIG. 4.

FIG. 6 is a diagram illustrating a configuration example of an image processing device according to a third embodiment of the present disclosure.

FIG. 7 is a diagram for illustrating removal of a deviating feature point by a deviation movement amount removing unit illustrated in FIG. 6.

FIG. 8 is a diagram illustrating a configuration example of an image processing device according to a fourth embodiment of the present disclosure.

FIG. 9 is a diagram for illustrating an operation of a movement amount inclination calculation unit illustrated in FIG. 8.

FIG. 10 is a diagram for illustrating frame division and vector correction by the movement amount inclination calculation unit illustrated in FIG. 8.

FIG. 11A is a diagram illustrating a configuration example of an image processing device according to a fifth embodiment of the present disclosure.

FIG. 11B is a diagram illustrating another configuration example of the image processing device according to the fifth embodiment of the present disclosure.

FIG. 11C is a diagram illustrating still another configuration example of the image processing device according to the fifth embodiment of the present disclosure.

FIG. 11D is a diagram illustrating still another configuration example of the image processing device according to the fifth embodiment of the present disclosure.

FIG. 11E is a diagram illustrating still another configuration example of the image processing device according to the fifth embodiment of the present disclosure.

FIG. 11F is a diagram illustrating still another configuration example of the image processing device according to the fifth embodiment of the present disclosure.

### DESCRIPTION OF EMBODIMENTS

A description will be attached below of embodiments of the present disclosure with reference to the drawings.

### First Embodiment

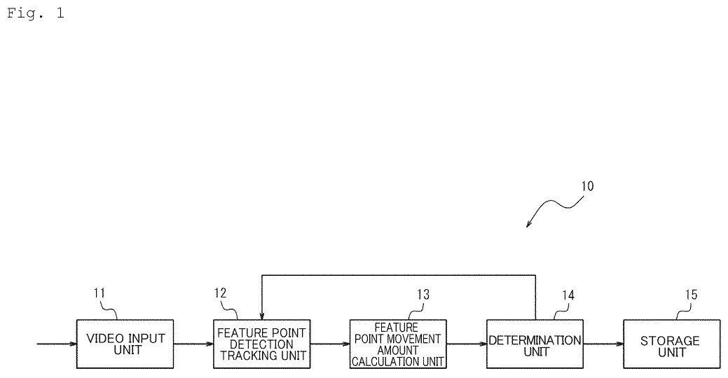

FIG. 1 is a diagram illustrating a configuration example of an image processing device 10 according to a first embodiment of the present disclosure. The image processing device 10 according to the present embodiment outputs, as a clipped frame, a frame at a timing at which a predetermined portion of an object is displaced by a predetermined amount in a moving image obtained by capturing the object such as an infrastructure structure while moving a viewpoint by capturing equipment mounted on a UAV or the like.

As illustrated in FIG. 1, the image processing device 10 according to the present embodiment includes a video input unit 11, a feature point detection tracking unit 12, a feature point movement amount calculation unit 13, a determination unit 14, and a storage unit 15.

The video input unit 11 receives a moving image captured by capturing equipment such as a digital video camera. The moving image is obtained by capturing an object such as an infrastructure structure by capturing equipment mounted on a moving body such as a UAV while moving a viewpoint, and configured of a plurality of frames (still images) arranged in time series. The resolution and frame rate of the moving image input to the video input unit 11 are arbitrary. The video input unit 11 outputs the input moving image to the feature point detection tracking unit 12.

The feature point detection tracking unit 12 detects feature points of a frame (first frame) at an arbitrary time t1 (first time) of the moving image output from the video input unit 11. The feature point is, for example, a pixel having luminance or color information satisfying a certain condition in a frame (still image). In addition, the feature point is, for example, a pixel in which a feature amount calculated from luminance or color gradient information around a certain pixel satisfies a certain condition. The feature point detection tracking unit 12 detects at least one or more feature points.

The feature point detection tracking unit 12 tracks the detected feature point from the time t1 to a time t2 (second time) later than the time t1, and calculates a two-dimensional vector indicating the movement of the feature point from the time t1 to the time t2. In a case of detecting a plurality of feature points, the feature point detection tracking unit 12 calculates the two-dimensional vector for each of the plurality of detected feature points. The tracking of the feature points can be performed by tracking processing based on optical flow, such as Lucas-Kanade method, for example. In a case where a plurality of frames exist between the time t1 and the time t2, the feature point detection tracking unit 12 calculates the two-dimensional vector of a feature point between two frames for each of one or a plurality of frames. It is possible to arbitrarily set how many frames the two-dimensional vector is to be calculated. At least one feature point is detected, and the parameters of the optical flow tracking process are adjusted so that a two-dimensional vector is calculated for the detected feature point from the time t1 to the time t2.

The feature point detection tracking unit 12 outputs the calculation result of the two-dimensional vector to the feature point movement amount calculation unit 13.

The feature point movement amount calculation unit 13 calculates a movement amount of the feature point based on the two-dimensional vector calculated by the feature point detection tracking unit 12. Specifically, the feature point movement amount calculation unit 13 calculates the total sum of the magnitudes of the two-dimensional vectors calculated between the time t1 and the time t2. In a case where the two-dimensional vector is calculated for one feature point, the feature point movement amount calculation unit 13 calculates the total sum of the magnitudes of the two-dimensional vectors as a movement amount.

In addition, in a case where the two-dimensional vector is calculated for each of the plurality of feature points, the feature point movement amount calculation unit 13 calculates the total sum of the magnitudes of the two-dimensional vectors calculated between the time t1 and the time t2 for all feature points. The feature point movement amount calculation unit 13 calculates a value obtained by dividing the total sum of the calculated magnitudes of the two-dimensional vectors by the number of feature points detected at the time t1 as a movement amount of the feature points. That is, in a case where a plurality of feature points are detected in the frame at the time t1, the feature point movement amount calculation unit 13 calculates an average value of the magnitude of the two-dimensional vector calculated for each of the plurality of feature points as a movement amount of the feature point.

For example, in a case where ten feature points are detected from the time t1 to the time t2 and the two-dimensional vector is calculated for each of the ten feature points, the feature point movement amount calculation unit 13 calculates an average value obtained by dividing the total sum of magnitudes of the two-dimensional vectors calculated for each of the ten feature points by 10 as a movement amount of the feature point.

The feature point movement amount calculation unit 13 outputs the calculation result of the movement amount of the feature point to the determination unit 14.

The determination unit 14 determines whether the movement amount calculated by the feature point movement amount calculation unit 13 is equal to or greater than a predetermined threshold value. When the determination unit 14 determines that the calculated movement amount is equal to or greater than a predetermined threshold value, the determination unit 14 outputs a frame (second frame) at the time t2 to the storage unit 15 as a clipped frame and stores the clipped frame. On the other hand, in a case where it is determined that the calculated movement amount is not equal to or greater than the predetermined threshold vale, the determination unit 14 does not output (does not store) the frame at the time t2 to the storage unit 15.

In a case where the movement amount of the feature point from the time t1 to the time t2 is equal to or greater than a predetermined threshold value, it is considered that a predetermined portion of the object within the angle of view has moved by a predetermined amount from the time t1 to the time t2. Therefore, in a case where the movement amount of the feature point from the time t1 to the time t2 is equal to or greater than a predetermined threshold value, the image processing device 10 according to the present embodiment outputs a frame at the time t2 to the storage unit 15 as a clipped frame and stores the clipped frame. Thus, in the moving image obtained by capturing the object while moving the viewpoint, a frame at a timing when a predetermined portion of the object is displaced by a predetermined amount can be output.

In a case where the frame at the time t2 is stored in the storage unit 15 as a clipped frame, the determination unit 14 notifies the feature point detection tracking unit 12 that the frame at the time t2 has been stored. When it is notified that the frame at the time t2 is stored, the feature point detection tracking unit 12 detects the feature point and tracks the detected feature point using a frame next to the frame at the time t2 as a frame at the new time t1.

In addition, in a case where the frame at the time t2 is not stored in the storage unit 15 as a clipped frame, the determination unit 14 notifies the feature point detection tracking unit 12 that the frame at the time t2 is not stored. When it is notified that the frame at the time t2 is not stored, the feature point detection tracking unit 12 tracks the feature point detected in the frame at the time t1 from the time t1 to the new time t2 using the time t2+Δt at which a predetermined time Δt elapses from the time t2 as the new time t2. An arbitrary time can be set as the predetermined time Δt.

The above-described processing is repeated until the new time t1 or the new time t2 exceeds the final time of the inputted moving image.

Next, the operation of the image processing device 10 according to the present embodiment will be described.

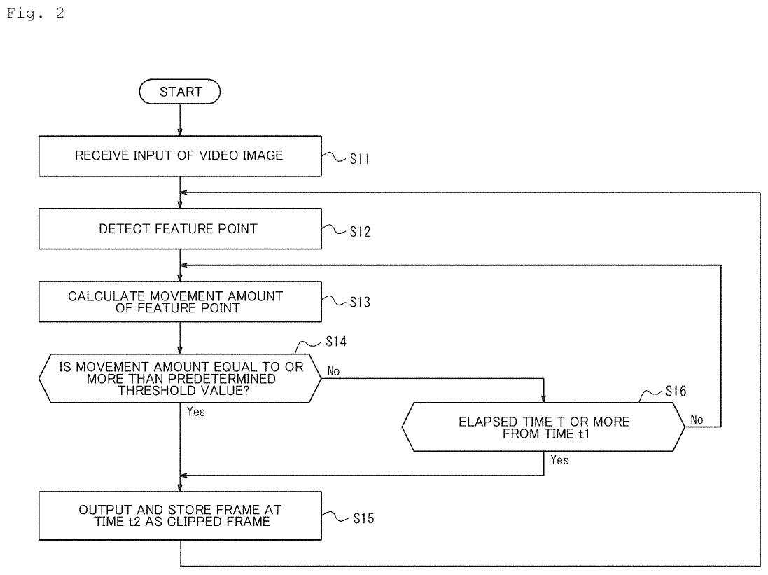

FIG. 2 is a flowchart illustrating an example of the operation of the image processing device 10 according to the present embodiment, and is a diagram for illustrating an image processing method by the image processing device 10.

The video input unit 11 receives input of the moving image obtained by capturing an object while moving a viewpoint (Step S11).

The feature point detection tracking unit 12 detects a feature point of a frame at an arbitrary time t1 (Step S12). Then, the feature point detection tracking unit 12 tracks the detected feature point from the time t1 to the time t2 after x seconds from the time t1, and calculates the two-dimensional vector indicating the motion of the feature point.

The feature point movement amount calculation unit 13 calculates the movement amount of the feature point based on the two-dimensional vector calculated by the feature point detection tracking unit 12 (Step S13).

The determination unit 14 determines whether the movement amount calculated by the feature point movement amount calculation unit 13 is equal to or greater than a predetermined threshold value (Step S14).

In a case where it is determined that the calculated movement amount is equal to or greater than a predetermined threshold value (Step S14: Yes), the determination unit 14 outputs a frame at the time t2 to the storage unit 15 as a clipped frame and stores the clipped frame. After the frame at the time t2 is stored in the storage unit 15 as a clipped frame, the time t1 is updated, and processing is repeated from Step S12.

In a case where it is determined that the calculated movement amount is not equal to or greater than a predetermined threshold value (Step S14: No), the determination unit 14 determines whether a predetermined threshold value T or greater has elapsed from the time t1, that is, whether an elapsed time from the time t1 to the time t2 is T or greater (Step S16).

In a case where it is determined that the predetermined threshold value T or greater has passed from the time t1 (Step S16: Yes), the determination unit 14 outputs a frame at the time t2 to the storage unit 15 as a clipped frame and stores the clipped frame (Step S15). Thus, even in a case where an error or the like occurs in image recognition, the processing is prevented from being finished without storing the clipped frame at all.

In a case where it is determined that the predetermined threshold value T or greater has not passed from the time t1 (Step S16: No), the determination unit 14 notifies the feature point detection tracking unit 12 that the frame at the time t2 is not stored as a clipped frame. By this notification, a two-dimensional vector is calculated by the feature point detection tracking unit 12 until a new time t2 and a movement amount is calculated by the feature point movement amount calculation unit 13.

Next, a hardware configuration of the image processing device 10 according to the present embodiment will be described.

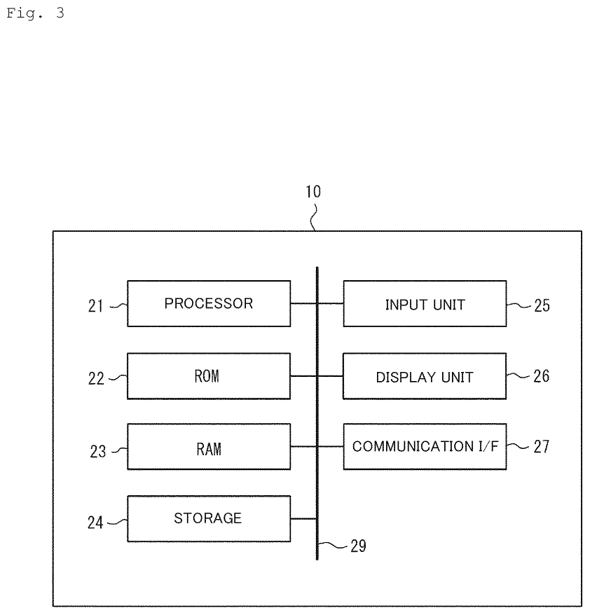

FIG. 3 is a diagram illustrating an example of the hardware configuration of the image processing device 10 according to the present embodiment. FIG. 3 illustrates an example of the hardware configuration of the image processing device 10 in a case where the image processing device 10 is configured by a computer capable of executing a program instruction. In this case, the computer may be any of a general-purpose computer, a dedicated computer, a work station, a personal computer (PC), an electronic notepad, or the like. The program instructions may be program codes, code segments, or the like for executing necessary tasks.

As illustrated in FIG. 3, the image processing device 10 includes a processor 21, a read only memory (ROM) 22, a random access memory (RAM) 23, a storage 24, an input unit 25, a display unit 26, and a communication interface (I/F) 27. The respective components are communicatively connected to each other via a bus 29. Specifically, the processor 21 is a central processing unit (CPU), a micro processing unit (MPU), a graphics processing unit (GPU), a digital signal processor (DSP), a system on a chip (SoC), and the like and may be configured by a plurality of processors of the same type or different types.

The processor 21 is a control unit that controls each configuration and executes various arithmetic processing. That is, the processor 21 reads out a program from the ROM 22 or the storage 24 and executes the program using RAM 23 as a work area. The processor 21 performs control of each component and various types of arithmetic processing according to programs stored in the ROM 22 or the storage 24. In the present embodiment, the ROM 22 or the storage 24 stores a program for causing a computer to function as the image processing device 10 according to the present disclosure. By reading out and executing the program by the processor 21, each component of the image processing device 10, that is, the feature point detection tracking unit 12, the feature point movement amount calculation unit 13, and the determination unit 14 are realized.

The program may be provided by being stored on a non-transitory storage medium such as a compact disk read only memory (CD-ROM), a digital versatile disk read only memory (DVD-ROM), or a universal serial bus (USB) memory. Further, the program may be downloaded from an external device via a network.

The ROM 22 stores various programs and various types of data. The RAM 23 temporarily stores programs or data as a work area. The storage 24 is constituted by a hard disk drive (HDD) or a solid state drive (SSD) and stores various programs, including an operating system, and various data. The ROM 22 or the storage 24 stores, for example, a frame outputted as a clipped frame.

The input unit 25 includes a pointing device such as a mouse and a keyboard, and is used for various inputs.

The display unit 26 is, for example, a liquid crystal display, and displays various types of information. A touch panel system may be employed as the display unit 26, which may function as the input unit 25.

The communication interface 27 is an interface for communicating with another device (for example, capturing equipment that shoots a moving image), and is, for example, a LAN interface.

A computer can be suitably used to function as the units of the image processing device 10 described above. Such a computer can be realized by storing a program describing the details of processing realizing the functions of the image processing device 10 in a storage unit of the computer and allowing a processor of the computer to read and execute the program. That is, the program can cause the computer to function as the above-described image processing device 10. Further, the program can be recorded on a non-temporary recording medium. The program may also be provided via a network.

As described above, the image processing device 10 according to the present embodiment includes the feature point detection tracking unit 12, the feature point movement amount calculation unit 13, and the determination unit 14. The feature point detection tracking unit 12 detects feature points in a frame (first frame) at the time t1 (first time), tracks the feature points from the time t1 to the time t2 (second time) later than the time t1, and calculates a two-dimensional vector indicating the movement of the feature points. The feature point movement amount calculation unit 13 calculates a movement amount of the feature point based on the calculated two-dimensional vector. The determination unit 14 determines whether the calculated movement amount is equal to or greater than a predetermined threshold value, and outputs a frame (second frame) at the time t2 as a clipped frame when it is determined that the movement amount is equal to or greater than the threshold value.

In a case where the movement amount of the feature point from the time t1 to the time t2 is equal to or greater than a predetermined threshold value, it is considered that a predetermined portion of the object within the angle of view has moved by a predetermined amount from the time t1 to the time t2. Therefore, the image processing device 10 according to the present embodiment outputs a frame at the time t2 as a clipped frame when the movement amount of the feature point becomes equal to or greater than a predetermined threshold value. Thus, in a moving image obtained by capturing the object while moving the viewpoint, a frame at a timing when a predetermined portion of the object is displaced by a predetermined amount can be output.

### Second Embodiment

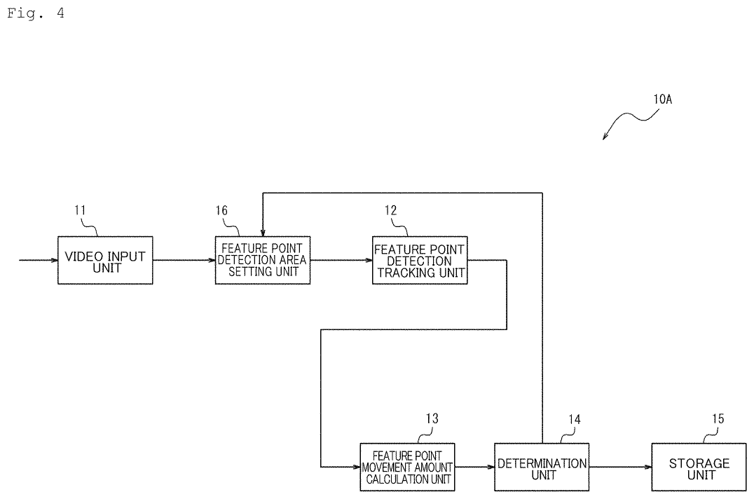

FIG. 4 is a view illustrating a configuration example of an image processing device 10A according to a second embodiment of the present disclosure.

The image processing device 10A illustrated in FIG. 4 differs from the image processing device 10 illustrated in FIG. 1 in that a feature point detection area setting unit 16 is added.

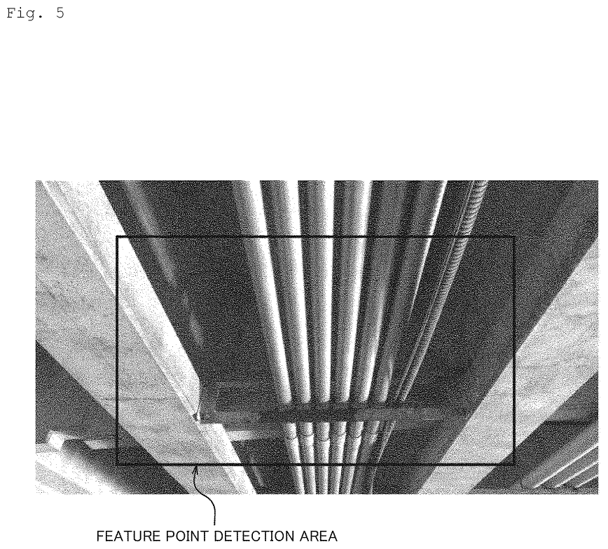

As illustrated in FIG. 5, the feature point detection area setting unit 16 sets a feature point detection area which is an area for detecting a feature point in the frame of the input moving image. The feature point detection area setting unit 16 sets a feature point detection area in response to an input from a user through the input unit 25, for example. The feature point detection tracking unit 12 detects and tracks a feature point in a feature point detection area set by the feature point detection area setting unit 16 of a frame from the time t1 to the time t2.

Although FIG. 5 illustrates an example in which the feature point detection area is rectangular, it is not limited thereto, and the feature point detection area may be set in any shape.

Thus, in this embodiment, the image processing device 10A further includes the feature point detection area setting unit 16 for setting a feature point detection area which is an area for detecting a feature point in the frame. Then, the feature point detection tracking unit 12 detects and tracks a feature point in the set feature point detection area.

By setting the feature point detection area, it is possible to prevent the feature point detected in the frame at the time t1 from deviating from the frame until the time t2 due to the movement of the viewpoint of the capturing equipment. For example, in a case where a feature point is detected by a pixel close to an end of the frame in the frame at the time t1, the viewpoint of the capturing equipment moves, and therefore, there is a high possibility that the feature point does not appear in the frame at the subsequent time. Therefore, in a case where the capturing equipment captures at the center part of the frame or while moving in a fixed direction, an area where the object exists in the next frame, it is effective to set a feature point detection area.

### Third Embodiment

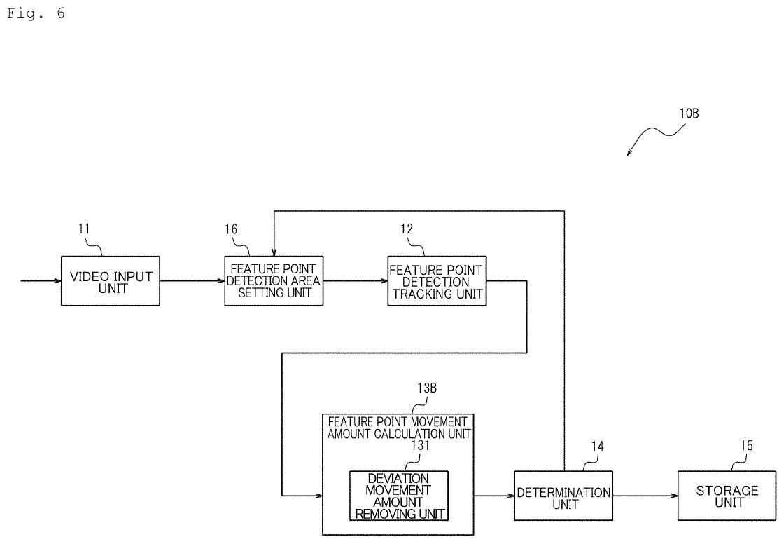

FIG. 6 is a view illustrating a configuration example of an image processing device 10B according to a third embodiment of the present disclosure.

The image processing device 10B illustrated in FIG. 6 differs from the image processing device 10A illustrated in FIG. 4 in that the feature point movement amount calculation unit 13 is changed to the feature point movement amount calculation unit 13B. The feature point movement amount calculation unit 13B includes a deviation movement amount removing unit 131.

As described above, when a plurality of feature points are detected in the frame at the time t1, the feature point detection tracking unit 12 calculates a two-dimensional vector for each of the plurality of detected feature points. The deviation movement amount removing unit 131 divides the total sum of the magnitudes of the two-dimensional vectors calculated for each of the plurality of feature points by the number of feature points detected at the time t1. That is, the deviation movement amount removing unit 131 calculates an average value of the magnitude of the two-dimensional vector calculated for each of the plurality of feature points. Then, the deviation movement amount removing unit 131 determines whether there is a feature point whose the magnitude of the two-dimensional vector exceeds a predetermined range (for example, average value+several %) with respect to respect to the calculated average value among the plurality of feature points (hereinafter, referred to as “deviation feature point”). When there is the deviation feature point, the deviation movement amount removing unit 131 calculates an average value of the magnitude of the two-dimensional vector calculated for the feature point excluding the deviation feature point among the plurality of detected feature points as a movement amount of the feature point.

As described above, in the present embodiment, the feature point movement amount calculation unit 13B (deviation movement amount removing unit 131) calculates an average value of the magnitude of the two-dimensional vector calculated for each of the plurality of feature points. Then, in a case where there is the deviation feature point where the magnitude of the calculated two-dimensional vector exceeds a predetermined range with respect to the average value among the plurality of feature points, the feature point movement amount calculation unit 13B calculates the average value of the magnitudes of the two-dimensional vectors calculated for the feature points excluding the deviation feature points among the plurality of feature points as the movement amount of the feature point.

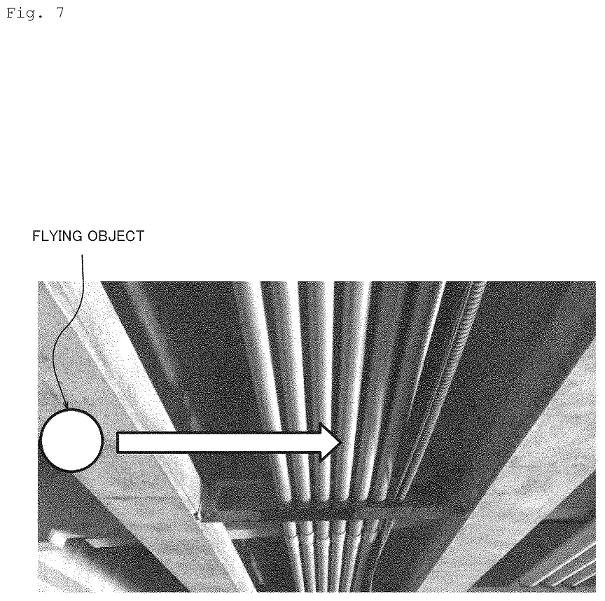

For example, as illustrated in FIG. 7, in a case where a flying object such as a bird crosses in a frame at a speed faster than a viewpoint of capturing equipment, if processing of an optical flow occurs with respect to the flying object, there is a possibility that a two-dimensional vector of a feature point corresponding to a flying object becomes large, and erroneous processing such that a viewpoint of the capturing equipment moves quickly may occur. As in the present embodiment, by excluding the deviation feature points in which the magnitudes of two-dimensional vector exceeds a predetermined range with respect to the average value of the magnitudes of two-dimensional vector calculated for the plurality of feature points, the feature points caused by the flying object as described above can be excluded from the calculation of the movement amount.

In this embodiment, although the feature point movement amount calculation unit 13 of the image processing device 10A according to the second embodiment is changed to the feature point movement amount calculation unit 13B, the present invention is not limited thereto. The feature point movement amount calculation unit 13 of the image processing device 10 according to the first embodiment may be changed to the feature point movement amount calculation unit 13B.

### Fourth Embodiment

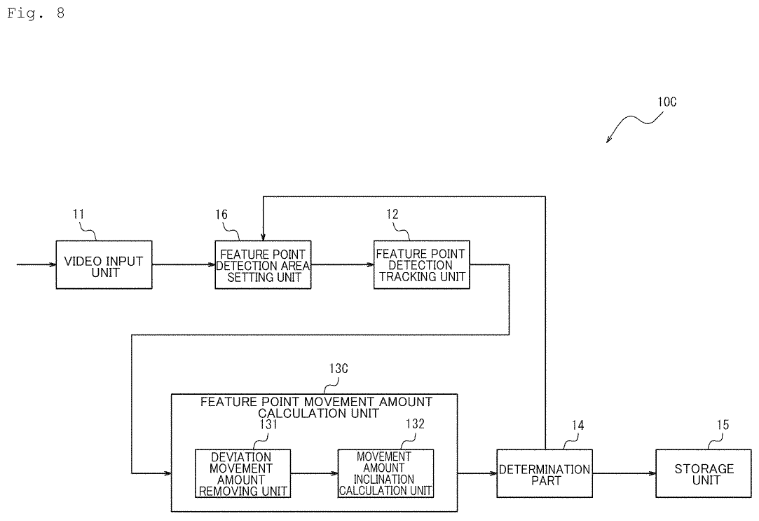

FIG. 8 is a diagram illustrating a configuration example of an image processing device 10C according to a fourth embodiment of the present disclosure.

The image processing device 10C illustrated in FIG. 8 differs from the image processing device 10B illustrated in FIG. 6 in that the feature point movement amount calculation unit 13B is changed to the feature point movement amount calculation unit 13C. The feature point movement amount calculation unit 13C is different from the feature point movement amount calculation unit 13B in that a movement amount inclination calculation unit 132 is added.

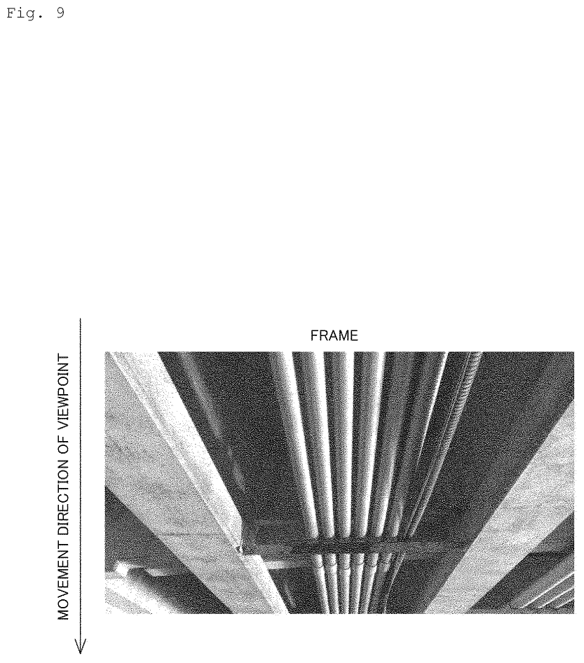

The movement amount inclination calculation unit 132 sets the magnitude of vector components other than the vector components in the specific direction to 0 when calculating the total sum of the magnitudes of the two-dimensional vectors of the feature points in the feature point movement amount calculation unit 13C. For example, as illustrated in FIG. 9, in a case where the viewpoint in capturing moves downward from the upper side to the lower side of the frame, the movement amount inclination calculation unit 132 sets the magnitude of vector components other than the vector components in the same direction or the opposite direction as the movement direction of the viewpoint to 0.

That is, in this embodiment, a feature point movement amount calculation unit 13C calculates a movement amount using only a vector component in a specific direction among two-dimensional vector components of the feature point. Thus, when capturing outdoors, for example, even in a case where the viewpoint of the capturing equipment moves unintentionally due to factors such as wind or unstable installation of the equipment, the effect of unintended movement of the viewpoint is reduced, and it is possible to more accurately calculate the movement amount of the feature point only in the direction in which the viewpoint moves.

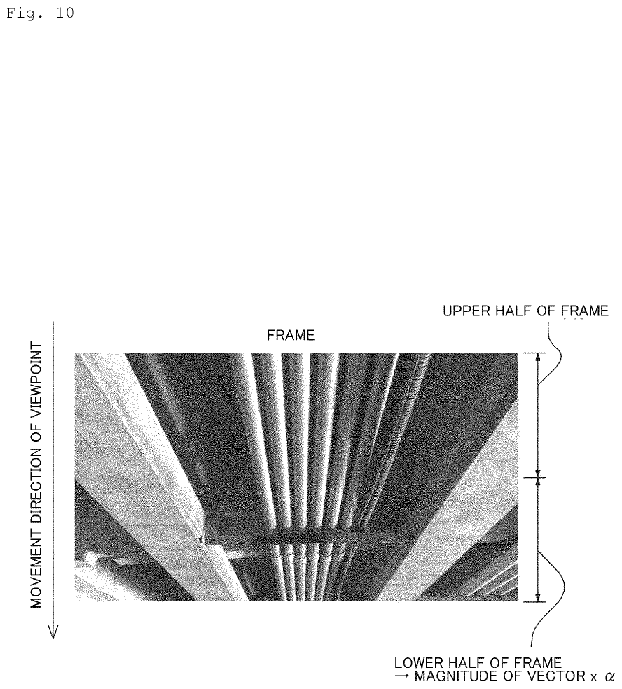

The movement amount inclination calculation unit 132 may divide the frame into a plurality of areas and adjust the magnitudes of two-dimensional vector according to the area including the two-dimensional vector of the feature point. For example, as illustrated in FIG. 10, the movement amount inclination calculation unit 132 divides the frame into upper and lower halves, and the magnitude of the two-dimensional vector included in the upper half region may be left unchanged, and the magnitude of the two-dimensional vector included in the lower half region may be multiplied by a predetermined coefficient α.

For example, when an object is captured at a constant elevation angle, the object actually captured in the frame may be farther in the lower part of the frame than in the upper part of the frame. In this case, the magnitude of the lower two-dimensional vector of the frame may be smaller than that of the upper two-dimensional vector of the frame. Therefore, by dividing the frame into a plurality of areas and adjusting the magnitudes of two-dimensional vector according to the area including the two-dimensional vector, the influence of capturing at a constant elevation angle is reduced, and the movement amount can be more accurately calculated.

In FIG. 10, the example in which the frame is divided into upper and lower parts was used. However, the method of dividing the frame is not limited to this, and the frame may be divided in any number and in any direction according to the conditions.

In the present embodiment, the example in which the feature point movement amount calculation unit 13B of the image processing device 10B according to the third embodiment is changed to the feature point movement amount calculation unit 13C has been described. However, it is not limited thereto. The feature point movement amount calculation unit 13 of the image processing device 10 according to the first embodiment or the image processing device 10A according to the second embodiment may be changed to the feature point movement amount calculation unit 13C.

### Fifth Embodiment

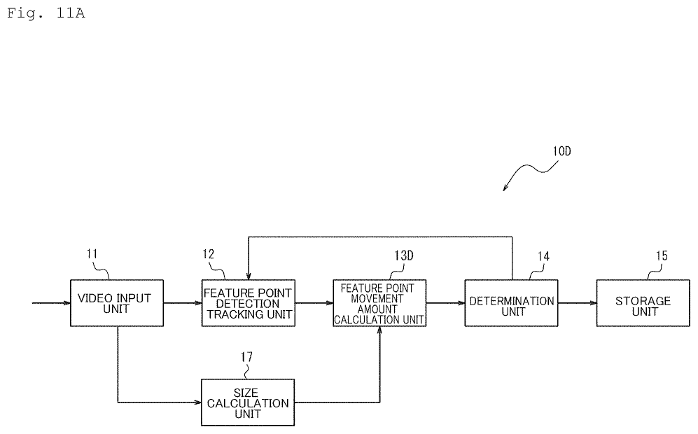

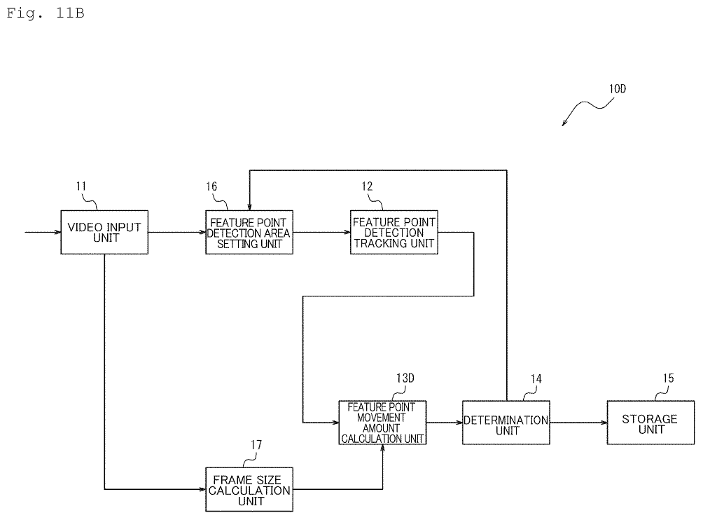

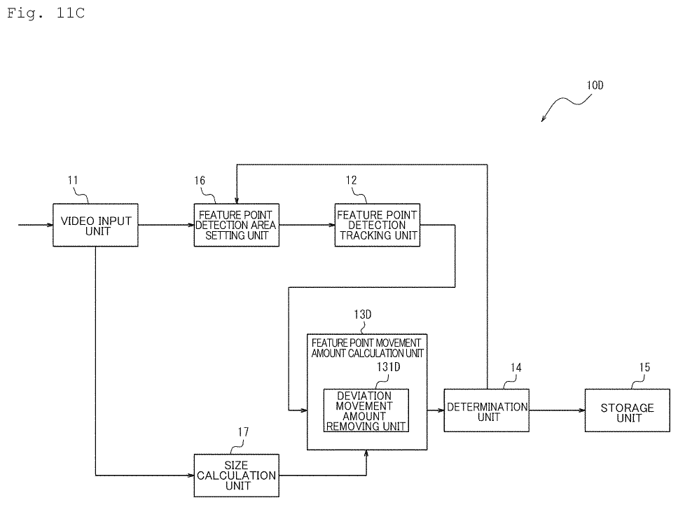

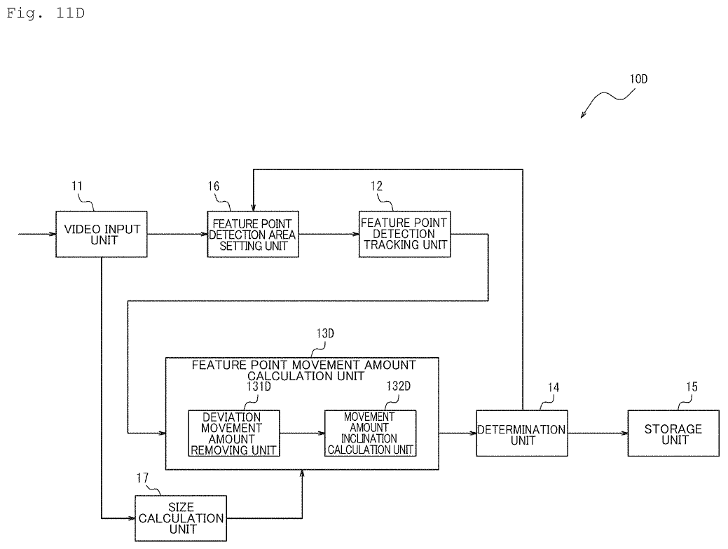

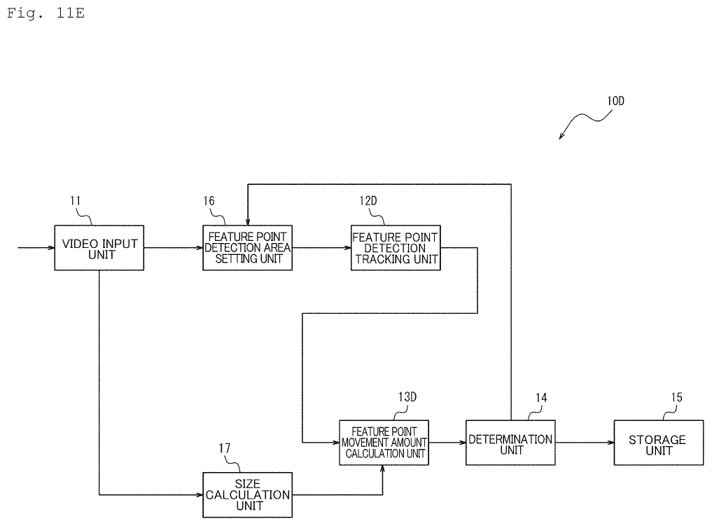

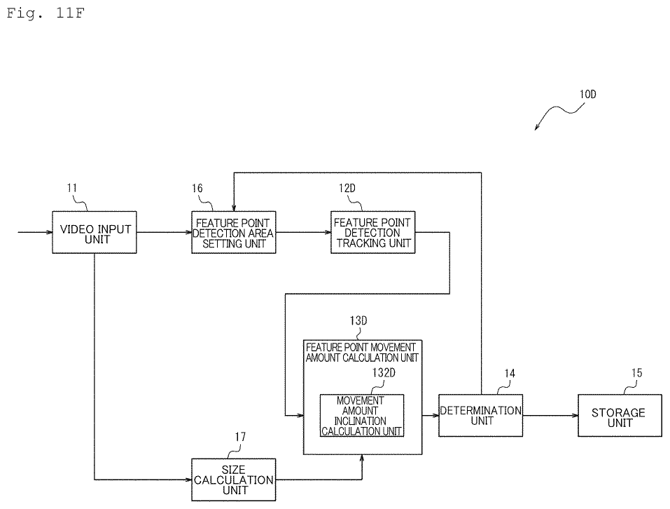

FIG. 11A is a diagram illustrating a configuration example of an image processing device 10D according a fifth embodiment of the present disclosure. In FIG. 11A, the same components as in FIG. 1 are denoted by the same reference numerals, and the description thereof is omitted.

As illustrated in FIG. 11A, an image processing device 10D according to the present embodiment includes the video input unit 11, the feature point detection tracking unit 12, the feature point movement amount calculation unit 13D, the determination unit 14, the storage unit 15, and a size calculation unit 17. The image processing device 10D illustrated in FIG. 11A differs from the image processing device 10 illustrated in FIG. 1 in that the size calculation unit 17 is added and that the feature point movement amount calculation unit 13 is changed to the feature point movement amount calculation unit 13D.

A moving image is input from the video input unit 11 to the size calculation unit 17. The size calculation unit 17 calculates the size in the lateral direction and the size in the longitudinal direction (first direction and second direction) of a frame (still image) constituting the inputted moving image. The size calculation unit 17 outputs the calculation result to the feature point movement amount calculation unit 13D.

The feature point movement amount calculation unit 13D calculates the movement amount of the feature point based on the two-dimensional vector calculated by the feature point detection tracking unit 12 similarly to the feature point movement amount calculation unit 13. Here, the feature point movement amount calculation unit 13D standardizes the movement amount of the feature point in accordance with the ratio between the lateral size and the longitudinal size of the frame calculated by the size calculation unit 17.

Specifically, the feature point movement amount calculation unit 13D calculates a synthetic vector of two-dimensional vectors calculated between the time t1 and the time t2. In a case where a two-dimensional vector is calculated for one feature point, the feature point movement amount calculation unit 13D defines the two-dimensional vector as a synthetic vector.

In addition, in a case where the two-dimensional vector is calculated for each of the plurality of feature points, the feature point movement amount calculation unit 13D synthesizes two-dimensional vectors calculated for all feature points from the time t1 to the time t2, and then divides the magnitude of the vector by the number of feature points detected at the time t1 to obtain a vector as synthetic vector.

For example, in a case where ten feature points are detected from the time t1 to the time t2 and the two-dimensional vector is calculated for each of the ten feature points, the feature point movement amount calculation unit 13D synthesizes the two-dimensional vectors calculated for each of the ten feature points, and then calculates a vector obtained by dividing the magnitude of the vector by 10 as a synthetic vector. The feature point movement amount calculation unit 13D calculates the movement amount of the feature point from the calculated synthetic vector according to Equation (1) below.

$$[ Math . 1 ]$$

$$Movement amount - ( \frac{{a}^{2}}{{w}^{2}} + \frac{{b}^{2}}{{h}^{2}} ) \qquad Equation ( 1 )$$

In Equation (1), a is the magnitude of the horizontal component (horizontal direction) of the synthetic vector, b is the magnitude of the vertical component (vertical direction) of the synthetic vector, w is the size of the frame (still image) in the horizontal direction, and h is the size of the frame (still image) in the vertical direction. By dividing the magnitude of the horizontal component of the synthetic vector by the size in the lateral direction of the frame and dividing the vertical component of the synthetic vector by the size in the longitudinal direction of the frame, the movement amount can be standardized in accordance with the ratio of the size in the lateral direction to the size in the longitudinal direction of the frame. By standardizing the movement amount in accordance with the ratio of the size in the lateral direction to the size in the longitudinal direction of the frame, the timing when the predetermined portion of the object in the frame is displaced by a predetermined amount can be detected without being affected by the size in the lateral direction and the size in the longitudinal direction of the frame. The feature point movement amount calculation unit 13D outputs the calculation result of the movement amount of the feature point to the determination unit 14.

In this embodiment, the image processing device 10D has been described by using an example in which the size calculation unit 17 is added to the image processing device 10 according to the first embodiment and the feature point movement amount calculation unit 13 is changed to the feature point movement amount calculation unit 13D. However, it is not limited thereto.

For example, as illustrated in FIG. 11B, the image processing device 10D may have a configuration in which the size calculation unit 17 is added to the image processing device 10A according to the second embodiment and the feature point movement amount calculation unit 13 is changed to the feature point movement amount calculation unit 13D.

Also, for example, as illustrated in FIG. 11C, the image processing device 10D may have a configuration in which the size calculation unit 17 is added to the image processing device 10B according to the third embodiment, and the feature point movement amount calculation unit 13B is changed to the feature point movement amount calculation unit 13D. In this case, the feature point movement amount calculation unit 13D is provided with the deviation movement amount removing unit 131D as illustrated in FIG. 11C.

The deviation movement amount removing unit 131D determines whether there is a feature point (deviation movement point) in which the magnitudes of two-dimensional vector exceeds a predetermined range (for example, within an average value+−several %) among the plurality of feature points with respect to an average value of the magnitudes of two-dimensional vector calculated for each of the plurality of feature points. The feature point movement amount calculation unit 13D calculates a synthetic vector from a two-dimensional vector calculated for a feature point excluding the deviation feature point among the plurality of detected feature points when it is determined that the deviation feature point exists. Then, the feature point movement amount calculation unit 13D calculates the movement amount of the feature point from the calculated synthetic vector based on Equation (1) above.

Also, for example, as illustrated in FIG. 11D, the image processing device 10D may have a configuration in which the size calculation unit 17 is added to the image processing device 10C according to the fourth embodiment, and the feature point movement amount calculation unit 13C is changed to the feature point movement amount calculation unit 13D. In this case, the feature point movement amount calculation unit 13D is provided with the deviation movement amount removing unit 131D and the movement amount inclination calculation unit 132D as illustrated in FIG. 11D.

The movement amount inclination calculation unit 132D sets a vector component other than a vector component in a specific direction to 0 when calculating a synthetic vector of the two-dimensional vector of the feature point in the feature point movement amount calculation unit 13D. For example, as illustrated in FIG. 9, in a case where the viewpoint in capturing moves downward from the upper side to the lower side of the frame, the movement amount inclination calculation unit 132D sets a vector component other than a vector component in the same direction or reverse direction as the movement direction of the viewpoint to 0. The feature point movement amount calculation unit 13D calculates a synthetic vector from a two-dimensional vector in which vector components other than the vector components in the specific direction are set to 0, and calculates the movement amount of the feature point from the calculated synthetic vector based on Equation (1) above. That is, in this embodiment, the feature point movement amount calculation unit 13D calculates a synthetic vector using only a vector component in a specific direction among two-dimensional vector components of the feature point.

The movement amount inclination calculation unit 132D may divide the frame into a plurality of areas and adjust the magnitudes of two-dimensional vector according to the area including the two-dimensional vector of the feature point. For example, as illustrated in FIG. 10 the movement amount inclination calculation unit 132D divides the frame into upper and lower halves, and the magnitude of the two-dimensional vector included in the upper half region may be left unchanged, and the magnitude of the two-dimensional vector included in the lower half region may be multiplied by a predetermined coefficient α.

Further, as illustrated in FIG. 11E, the image processing device 10D according to the present embodiment may have a configuration in which the feature point detection tracking unit 12 is changed to the feature point detection tracking unit 12D compared to the image processing device 10D illustrated in FIG. 11B.

The feature point detection tracking unit 12D calculates a two-dimensional vector by an optical flow from the time t1 to the time t2 for all pixels in the area designated as the feature point detection area by the feature point detection area setting unit 16. The feature point movement amount calculation unit 13D calculates the movement amount of the feature point based on the two-dimensional vector calculated by the feature point detection tracking unit 12D.

Specifically, the feature point movement amount calculation unit 13D calculates a synthetic vector of two-dimensional vectors of all pixels calculated from the time t1 to the time t2, and calculates the movement amount of the feature point from the calculated synthetic vector based on Equation (1) above. By calculating the two-dimensional vector for all the pixels, it is possible to cope with a sudden change in the amount of movement due to loss of the feature point being tracked and erroneous recognition of the feature point with respect to a method for tracking a specific feature point.

In the image processing device 10D according to the present embodiment, as illustrated in FIG. 11F, in the image processing device 10D illustrated in FIG. 11E, the feature point movement amount calculation unit 13D may have a movement inclination calculation unit 132D.

The image processing device 10A according to the second embodiment, the image processing device 10B according to the third embodiment, the image processing device 10C according to the fourth embodiment, and the image processing device 10D according to the fifth embodiment can also be constituted by a computer having the hardware configuration described with reference to FIG. 3.

The following additional remarks are disclosed in relation to the embodiments described above.

### (Supplement Item 1)

An image processing device for outputting a frame at a timing when a predetermined part of an object is displaced by a predetermined amount as a clipped frame from a moving image formed by a plurality of frames and capturing the object while a viewpoint is moved, the device comprising:

a memory, and
a control unit connected to the memory,
wherein
the control unit
detects a feature point in a first frame that is a frame at a first time, tracks the feature point from the first time to a second time later than the first time, and calculates a two-dimensional vector indicating a motion of the feature point, calculates a movement amount of the feature point based on the calculated two-dimensional vector, and
determines whether the calculated movement amount is equal to or greater than a predetermined threshold value, and outputs a second frame as the clipped frame, the second frame being a frame at the second time, when the movement amount is determined to be equal to or greater than the threshold value.

### (Supplement Item 2)

The image processing device according to Supplement Item 1, in which
the control unit
sets a feature point detection area that is an area for detecting the feature point in the frame, and
detects and tracks the feature point in the set feature point detection area.

### (Supplement Item 3)

The image processing device according to Supplement Item 1 or 2, in which
the control unit
calculates, in a case where the plurality of feature points are detected in the first frame, the two-dimensional vector for each of the plurality of detected feature points, and calculates an average value of magnitudes of the two-dimensional vectors calculated for each of the plurality of feature points as the movement amount.

### (Supplement Item 4)

The image processing device according to Supplement Item 1 or 2, in which
the control unit
calculates, in a case where the plurality of feature points are detected in the first frame, the two-dimensional vector for each of the plurality of detected feature points, and calculates an average value of magnitudes of two-dimensional vectors calculated for each of the plurality of feature points, and in a case where there is an deviation feature point, which is a feature point in which the calculated magnitudes of two-dimensional vector exceeds a predetermined range with respect to the average value, among the plurality of feature points, calculates an average value of magnitudes of two-dimensional vectors calculated for the feature points excluding the deviation feature points among the plurality of feature points as the movement amount.

### (Supplement Item 5)

The image processing device according to any one of Supplement Items 1 to 4, in which
the control unit calculates the movement amount using only a vector component in a specific direction among vector components of the two-dimensional vector.

### (Supplement Item 6)

The image processing device according to any one of Supplement Items 1 to 5, in which the control unit divides the frame into a plurality of areas, and adjusts a magnitude of two-dimensional vector according to an area including the two-dimensional vector.

### (Supplement Item 7)

The image processing device according to Supplement Item 1, further including
a size calculation unit that calculates a size of the frame in a first direction and a size of the frame in a second direction orthogonal to the first direction, in which the feature point movement amount calculation unit normalizes the movement amount in accordance with a ratio between a size of the frame in the first direction and a size of the frame in the second direction detected by the size calculation unit.

### (Supplement Item 8)

An image processing method for outputting a frame as a clipped frame at a timing when a predetermined portion of an object is displaced by a predetermined amount in a moving image formed by a plurality of frames and capturing the object while moving a viewpoint, the method including
detecting a feature point in a first frame that is a frame at a first time, tracks the feature point from the first time to a second time later than the first time, and calculating a two-dimensional vector indicating a motion of the feature point,
calculating a movement amount of the feature point based on the calculated two-dimensional vector, and
determining whether the calculated movement amount is equal to or greater than a predetermined threshold value, and outputting a second frame as the clipped frame, the second frame being a frame at the second time, when the movement amount is determined to be equal to or greater than the threshold value.

### (Supplement Item 9)

A non-transitory storage medium storing a program executable by a computer, the non-transitory storage medium storing the program causing the computer to function as the image processing device according to any one of Supplement Items 1 to 7.

Although the above embodiment is described as a representative example, it is clear for those skilled in the art that many changes and replacement can be carried out within the gist and the scope of the present disclosure. Therefore, the embodiment described above should not be interpreted as limiting and the present invention can be modified and changed in various ways without departing from the scope of the claims. For example, a plurality of configuration blocks shown in the configuration diagrams of the embodiments may be combined to one, or one configuration block may be divided.

### REFERENCE SIGNS LIST

10, 10A, 10B, 10C Image processing device
11 Video input unit
12 Feature point detection and tracking unit
13, 13B, 13C, 13D Feature point movement amount calculation unit
14 Determination unit
15 Storage unit
16 Feature point detection area setting unit
17 Size calculation unit
131, 131D Deviation movement amount removing unit
132, 132D Movement amount inclination calculation unit
21 Processor
22 ROM
23 RAM
24 Storage
25 Input unit
26 Display unit
27 Communication I/F
29 Bus

1. An image processing device for outputting a frame at a timing when a predetermined part of an object is displaced by a predetermined amount as a clipped frame from a moving image formed by a plurality of frames and capturing the object while a viewpoint is moved, the device comprising:
a feature point detection tracking unit that detects a feature point in a first frame that is a frame at a first time, tracks the feature point from the first time to a second time later than the first time, and calculates a two-dimensional vector indicating a motion of the feature point;
a feature point movement amount calculation unit that calculates a movement amount of the feature point based on the calculated two-dimensional vector; and
a determination unit that determines whether the calculated movement amount is equal to or greater than a predetermined threshold value, and outputs a second frame as the clipped frame, the second frame being a frame at the second time, when the movement amount is determined to be equal to or greater than the threshold value.

2. The image processing device according to claim 1, further comprising:
a feature point detection area setting unit that sets a feature point detection area that is an area where the feature point is detected in the frame, wherein
the feature point detection tracking unit detects and tracks the feature point in the set feature point detection area.

3. The image processing device according to claim 1, wherein
the feature point detection tracking unit calculates, in a case where the plurality of feature points are detected in the first frame, the two-dimensional vector for each of the plurality of detected feature points, and
the feature point movement amount calculation unit calculates an average value of magnitudes of the two-dimensional vectors calculated for each of the plurality of feature points as the movement amount.

4. The image processing device according to claim 1, wherein
the feature point detection tracking unit calculates, in a case where the plurality of feature points are detected in the first frame, the two-dimensional vector for each of the plurality of detected feature points, and
the feature point movement amount calculation unit calculates an average value of magnitudes of two-dimensional vectors calculated for each of the plurality of feature points, and in a case where there is an deviation feature point, which is a feature point in which the calculated magnitudes of two-dimensional vector exceeds a predetermined range with respect to the average value, among the plurality of feature points, calculates an average value of magnitudes of two-dimensional vectors calculated for the feature points excluding the deviation feature points among the plurality of feature points as the movement amount.

5. The image processing device according to claim 1, wherein
the feature point movement amount calculation unit calculates the movement amount using only a vector component in a specific direction among vector components of the two-dimensional vector.

6. The image processing device according to claim 1, wherein
the feature point movement amount calculation unit divides the frame into a plurality of areas, and adjusts a magnitude of two-dimensional vector according to an area including the two-dimensional vector.

7. The image processing device according to claim 1, further comprising:
a size calculation unit that calculates a size of the frame in a first direction and a size of the frame in a second direction orthogonal to the first direction, wherein
the feature point movement amount calculation unit normalizes the movement amount in accordance with a ratio between a size of the frame in the first direction and a size of the frame in the second direction detected by the size calculation unit.

8. An image processing method for outputting a frame as a clipped frame at a timing when a predetermined portion of an object is displaced by a predetermined amount in a moving image formed by a plurality of frames and capturing the object while moving a viewpoint, the method comprising:
a step of detecting a feature point in a first frame that is a frame at a first time, tracks the feature point from the first time to a second time later than the first time, and calculating a two-dimensional vector indicating a motion of the feature point;
calculating a movement amount of the feature point based on the calculated two-dimensional vector; and
determining whether the calculated movement amount is equal to or greater than a predetermined threshold value, and outputting a second frame as the clipped frame, the second frame being a frame at the second time, when the movement amount is determined to be equal to or greater than the threshold value.

9. (canceled)

10. A computer-readable non-transitory recording medium storing computer-executable program instructions that when executed by a processor cause a computer to execute a program generation method comprising:
detecting a feature point in a first frame that is a frame at a first time, tracking the feature point from the first time to a second time later than the first time, and calculating a two-dimensional vector indicating a motion of the feature point;
calculating a movement amount of the feature point based on the calculated two-dimensional vector; and
determining whether the calculated movement amount is equal to or greater than a predetermined threshold value, and outputs a second frame as the clipped frame, the second frame being a frame at the second time, when the movement amount is determined to be equal to or greater than the threshold value.

11. The method of claim 10, further comprising:
setting a feature point detection area that is an area where the feature point is detected in the frame, wherein
the feature point is detected and tracked in the set feature point detection area.

12. The method of claim 10, further comprising:
calculating, in a case where the plurality of feature points are detected in the first frame, the two-dimensional vector for each of the plurality of detected feature points, and
calculating an average value of magnitudes of the two-dimensional vectors calculated for each of the plurality of feature points as the movement amount.

13. The method of claim 10, wherein
calculating, in a case where the plurality of feature points are detected in the first frame, the two-dimensional vector for each of the plurality of detected feature points, and
calculating an average value of magnitudes of two-dimensional vectors calculated for each of the plurality of feature points, and in a case where there is an deviation feature point, which is a feature point in which the calculated magnitudes of two-dimensional vector exceeds a predetermined range with respect to the average value, among the plurality of feature points, calculates an average value of magnitudes of two-dimensional vectors calculated for the feature points excluding the deviation feature points among the plurality of feature points as the movement amount.

14. The method of claim 10, wherein
the movement amount is calculated using only a vector component in a specific direction among vector components of the two-dimensional vector.

15. The method of claim 10, wherein
the frame is divided into a plurality of areas, and a magnitude of two-dimensional vector is adjusted according to an area including the two-dimensional vector.

16. The method of claim 10, further comprising:
calculating a size of the frame in a first direction and a size of the frame in a second direction orthogonal to the first direction, wherein
the movement amount is normalized in accordance with a ratio between a size of the frame in the first direction and a size of the frame in the second direction detected by the size calculation unit.

17. The image processing device according to claim 4, wherein if the magnitudes of the two-dimensional vectors for the deviation feature point exceeds a predetermined range with respect to an average value among the plurality of feature points, the average value of the magnitudes of the two-dimensional vectors for the feature points excluding a plurality of outlier feature points is calculated as an amount of movement of the feature points.

18. The image processing device according to claim 17, wherein the magnitudes of the two-dimensional vectors of the feature points are calculated, magnitudes of vector components other than a vector component in a specific direction is set to zero.

19. The image processing device according to claim 18, wherein a frame is divided into a plurality of regions and the magnitudes of the two-dimensional vectors are adjusted according to regions containing the two-dimensional vectors of the feature points.

20. The image processing device according to claim 19, wherein the frame is divided into an upper region and a lower region and while the magnitude of the two-dimensional vector of the upper regions is maintained, the magnitude of the two-dimensional vector of the lower region is multiplied by a predetermined coefficient.

21. The image processing device according to 1, wherein a synthetic vector of the two-dimensional vectors is calculated from a first time to a second time for one feature point.
